(19) United States
(12) Patent Application Publication
(10) Pub. No.: US 2011/0012527 A1
(43) Pub. Date: Jan. 20, 2011

(54) SYNCHRONOUS OPERATION SYSTEM FOR DISCHARGE LAMP LIGHTING APPARATUSES, DISCHARGE LAMP LIGHTING APPARATUS, AND SEMICONDUCTOR INTEGRATED CIRCUIT THEREOF

(75) Inventors: Kengo Kimura, Saitama (JP); Toshihiro Nakano, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/934,397

(22) PCT Filed: Feb. 25, 2009
(86) PCT No.: PCT/JP2009/053404

§ 371 Date: Sep. 24, 2010

(30) Foreign Application Priority Data
Mar. 24, 2008 (JP) 2008-076155

(51) Int. Cl. H05B 41/24

(52) U.S. Cl. 315/250

(57) ABSTRACT

Each of discharge lamp lighting apparatus that are connected to a common line includes a sawtooth-wave oscillator to generate a sawtooth signal for PWM-controlling a plurality of switching elements passing a current through a primary winding of a transformer and a capacitor of a resonant circuit connected to a discharge lamp, a PWM comparator controlling the plurality of switching elements according to the sawtooth signal, and a pulse synchronization circuit providing the common line with a synchronization pulse signal based on a pulse signal in relation to the sawtooth signal, and when receiving a synchronization pulse signal from the common line, synchronize the oscillation frequency of the sawtooth signal with the frequency of the synchronization pulse signal from the common line. So that a voltage of aligned frequency and phase is applied to one end of each discharge lamp.

### TECHNICAL FIELD

The present invention relates to a synchronous operation system for a plurality of discharge lamp lighting apparatuses that are connected to one another and are synchronously operated to light discharge lamps, in particular, cold cathode fluorescent lamps in, for example, a liquid crystal display device, as well as to a discharge lamp lighting apparatus and a semiconductor integrated circuit.

### BACKGROUND TECHNOLOGY

The screen sizes of liquid crystal display devices are on the increase and this has developed a tendency of distributing a plurality of discharge lamps (for example, cold cathode fluorescent lamps (CCFLs)) over a backlight. Light beams from the distributed discharge lamps interfere with one another to cause flickering. To avoid this, the discharge lamps must synchronously be lighted.

A related art concerning a parallel operation system for inverters is disclosed in, for example, Japanese Unexamined Patent Application Publication No. 2004-222489. FIG. 1 is a schematic view of the parallel operation system for inverters according to the related art. This parallel operation system for inverters arranges a plurality of discharge lamp inverters close to discharge lamps and synchronously controls them in phase. Each of the inverters serves as a discharge lamp lighting apparatus.

In FIG. 1, a start signal ST becomes high to increase a potential STB at terminal 11P of each of controller ICs 200A to 200N according to a time constant determined by a capacitor 142 and a resistor 143. When the potential STB exceeds a reference voltage Vref6, an output from a comparator 217 inverts from high to low, to turn on the controller ICs 200A to 200N.

When turned on, a mode circuit 201-2 in the main controller 200A generates a high-level mode output Vmode and an oscillation circuit 201-1 generates a clock signal CLK and a PWM triangular signal CT at a relatively high start frequency determined by a frequency determination capacitor 132, a frequency determination resistor 133, and a start resistor 134. A logic block 203 generates a synchronization signal TG based on the clock signal CLK.

The sub-controller ICs 200B to 200N are turned on nearly simultaneously with the main controller 200A. They, however, have no frequency determination resistor 133 connected to a terminal 4P, and therefore, do not generate the PWM triangular signal CT, clock signal CLK, and synchronization signal TG.

Based on the PWM triangular signal CT, clock signal CLK, and synchronization signal TG from the main controller 200A, the sub-controller ICs 200E to 200N each generate a PWM control signal. With this, the sub-inverters operate in synchronization with the main inverter having the main controller 200A in phase. Namely, all inverters synchronously operate in phase.

In this way, the parallel operation system for inverters illustrated in FIG. 1 sends the sawtooth and triangular waves of the oscillation circuit 201-1 of the main inverter having the main controller IC 200A to the sub-inverters having the sub-controller ICs 200B to 200N, thereby synchronizing the oscillation frequencies and phases of the plurality of inverters with one another. Alternatively, the system sends the sawtooth and triangular waves of the oscillation circuit 201-1 of the main inverter or rectangular signals synchronized with the oscillation circuit 201-1 to the sub-inverters, thereby synchronizing the oscillation frequencies and phases of the plurality of inverters.

### DISCLOSURE OF INVENTION

When lighting a straight discharge lamp such as a cold cathode fluorescent lamp by applying AC voltages of opposite phases to both ends of the lamp, each discharge lamp lighting apparatus must be arranged at each end of each discharge lamp.

This results in elongating a distance between the discharge lamp lighting apparatuses and the length of wiring to transmit a synchronization signal. Thus, oscillation frequencies fluctuate due to the influence of floating capacitance and the waveform of the synchronization signal distorts due to the influence of switching noise or high-voltage radiation of the discharge lamp, thereby unbalancing a current passing through the discharge lamp.

The present invention provides a synchronous operation system for discharge lamp lighting apparatuses, a discharge lamp lighting apparatus, and a semiconductor integrated circuit thereof, capable of stably and easily supplying positive-negative-symmetric AC power in the same or opposite phases at the same frequency to one or more discharge lamp lighting apparatuses even if they are separated away from one another.

### MEANS TO SOLVE THE PROBLEMS

To solve the problems, a first aspect of the present invention provides a synchronous operation system for discharge lamp lighting apparatuses, including one or more discharge lamp lighting apparatuses that are connected to one another with a common line and are configured to supply AC power to one or more discharge lamps. Each of the one or more discharge lamp lighting apparatuses includes a resonant circuit having a capacitor connected to at least one of primary and secondary windings of a transformer and an output connected to the discharge lamp, a plurality of switching elements connected to both ends of a DC power source, to pass a current through the primary winding of the transformer and the capacitor in the resonant circuit, a sawtooth-wave oscillator to generate a sawtooth signal for PWM-controlling the plurality of switching elements, a PWM comparator to output, based on the sawtooth signal from the sawtooth-wave oscillator, a PWM signal for controlling the plurality of switching elements, and a pulse synchronization circuit to provide the common line with a synchronization pulse signal based on a pulse signal that carries frequency information about the sawtooth signal from the sawtooth-wave oscillator, and when receiving a synchronization pulse signal from the common line, synchronize the oscillation frequency of the sawtooth signal from the sawtooth-wave oscillator with the frequency of the synchronization pulse signal from the common line. The synchronization pulse signal is transmitted/received among the one or more discharge lamp lighting apparatuses through the common line, so that a voltage of aligned frequency and phase is applied to one end of each of the one or more discharge lamps to light the one or more discharge lamps.

A second aspect of the present invention provides a synchronous operation system for discharge lamp lighting apparatuses, including one or more discharge lamp lighting apparatuses that are connected to one another with a common line and are configured to supply AC power to one or more discharge lamps. Each of the one or more discharge lamp lighting apparatuses includes a resonant circuit having a capacitor connected to at least one of primary and secondary windings of a transformer and an output connected to the discharge lamp, a plurality of switching elements connected to both ends of a DC power source, to pass a current through the primary winding of the transformer and the capacitor in the resonant circuit, a sawtooth-wave oscillator to generate a sawtooth signal for PWM-controlling the plurality of switching elements, a PWM comparator to output, based on the sawtooth signal from the sawtooth-wave oscillator, a PWM signal for controlling the plurality of switching elements, and a pulse synchronization circuit to provide the common line with a synchronization pulse signal based on a pulse signal that carries frequency information about the sawtooth signal from the sawtooth-wave oscillator, and when receiving a synchronization pulse signal from the common line, synchronize the oscillation frequency of the sawtooth signal from the sawtooth-wave oscillator with the frequency of the synchronization pulse signal from the common line. The synchronization pulse signal is transmitted/received among the one or more discharge lamp lighting apparatuses through the common line, so that voltages of aligned frequency and opposite phases are applied to both ends of each of the one or more discharge lamps to light the one or more discharge lamps.

A third aspect of the present invention provides a discharge lamp lighting apparatus including a resonant circuit having a capacitor connected to at least one of primary and secondary windings of a transformer and an output connected to a discharge lamp, a plurality of switching elements connected to both ends of a DC power source, to pass a current through the primary winding of the transformer and the capacitor in the resonant circuit, a sawtooth-wave oscillator to generate a sawtooth signal for PWM-controlling the plurality of switching elements, a PWM comparator to output, based on the sawtooth signal from the sawtooth-wave oscillator, a PWM signal for controlling the plurality of switching elements, and a pulse synchronization circuit to provide the output with a synchronization pulse signal based on a pulse signal that carries frequency information about the sawtooth signal from the sawtooth-wave oscillator, and when receiving an external synchronization pulse signal from the outside, synchronize the oscillation frequency of the sawtooth signal from the sawtooth-wave oscillator with the frequency of the synchronization pulse signal from the outside.

A fourth aspect of the present invention provides a semiconductor integrated circuit that controls a plurality of switching elements for turning on/off a power source that supplies power to a load. The semiconductor integrated circuit includes a sawtooth-wave oscillator to generate a sawtooth signal for PWM-controlling the plurality of switching elements, a PWM comparator to output, based on the sawtooth signal from the sawtooth-wave oscillator, a PWM signal for controlling the plurality of switching elements, and a pulse synchronization circuit to provide the outside with a synchronization pulse signal based on a pulse signal that carries frequency information about the sawtooth signal from the sawtooth-wave oscillator, and when receiving a synchronization pulse signal from the outside, synchronize the oscillation frequency of the sawtooth signal from the sawtooth-wave oscillator with the frequency of the synchronization pulse signal from the outside.

According to a fifth aspect of the present invention, the discharge lamp lighting apparatus or the semiconductor integrated circuit includes a signal comparator to provide the outside with a pulse signal that carries phase information about the PWM signal for the plurality of switching elements, and if receiving from the outside a pulse signal whose phase differs from the phase of the pulse signal of its own, output an out-of-phase detected signal and a restart circuit to reset the pulse signal according to the out-of-phase detected signal from the signal comparator, generate a restart signal for restarting each discharge lamp lighting apparatus, and output the restart signal to the outside.

### BRIEF DESCRIPTION OF DRAWINGS

FIG. 1 is a schematic view of a parallel operation system for inverters according to a related art.

FIG. 2 is a schematic view of a synchronous operation system for discharge lamp lighting apparatuses according to Embodiment 1 of the present invention.

FIG. 3 is a schematic view of a control circuit part arranged in the discharge lamp lighting apparatus of Embodiment 1 illustrated in FIG. 2.

FIG. 4 is a timing chart of a frequency synchronization operation of each discharge lamp light apparatus of Embodiment 1 illustrated in FIG. 2.

FIG. 5 is a timing chart of an out-of-phase detection operation of each discharge lamp lighting apparatus of Embodiment 1 illustrated in FIG. 2.

FIG. 6 is a schematic view of a synchronous operation system for discharge lamp lighting apparatuses according to Embodiment 2 of the present invention.

FIG. 7 is a timing chart of a frequency synchronization operation of each discharge lamp lighting apparatus of Embodiment 2 illustrated in FIG. 6.

FIG. 8 is a schematic view of a synchronous operation system for discharge lamp lighting apparatuses according to Embodiment 3 of the present invention.

FIG. 9 is a schematic view of a discharge lamp lighting apparatus according to Embodiment 4 of the present invention.

FIG. 10 is a schematic view of a control circuit part arranged in the discharge lamp lighting apparatus of Embodiment 4 illustrated in FIG. 9.

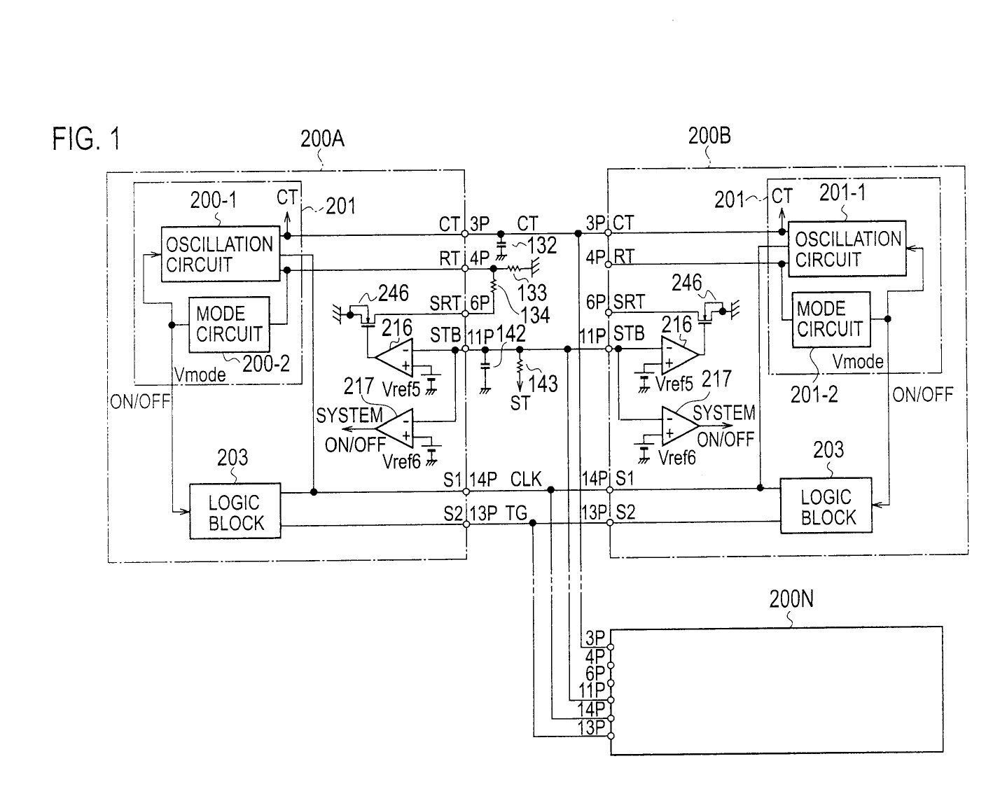

### BEST MODE OF IMPLEMENTING INVENTION

Synchronous operation systems for discharge lamp lighting apparatuses, discharge lamp lighting apparatuses, and semiconductor integrated circuits thereof according to embodiments of the present invention will be explained in detail with reference to the drawings.

The present invention conducts a digital process of transmitting and receiving only a pulse signal, to synchronize the oscillation frequencies and phases of one or more discharge lamp lighting apparatuses. If, at the start of operation or during operation, one of discharge lamps causes an AC-power phase inversion, the present invention conducts a digital process of transmitting and receiving only a pulse signal, to reset a pulse signal outputted from a sawtooth-wave oscillator of every discharge lamp lighting apparatus and adjust the apparatuses in phase.

### Embodiment 1

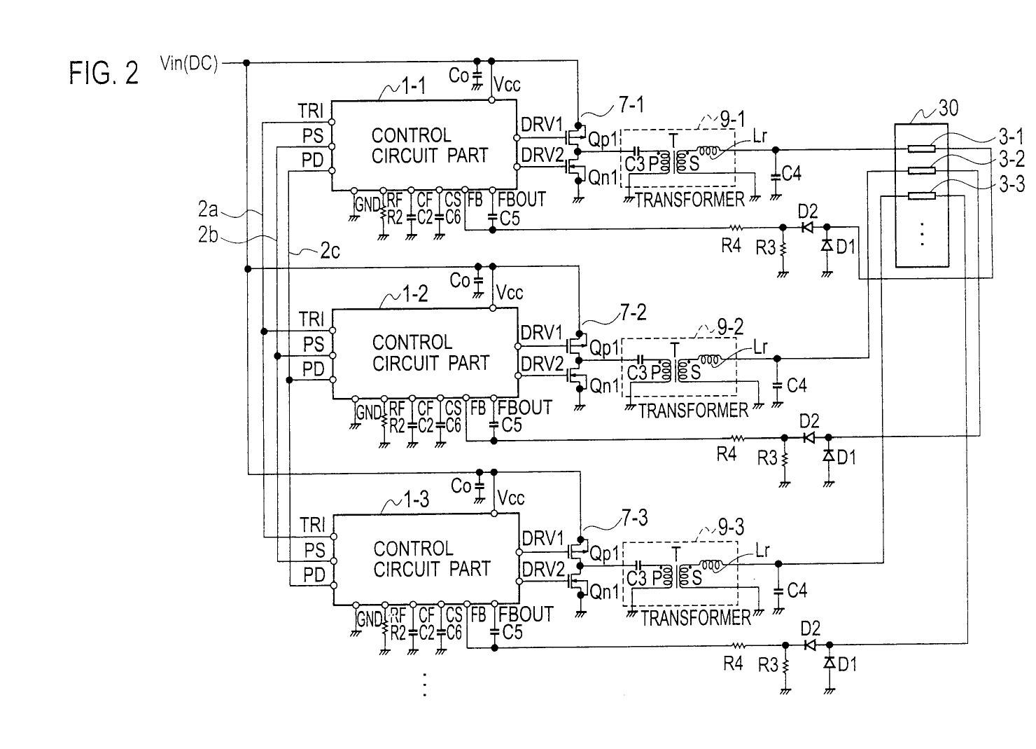

FIG. 2 is a schematic view of a synchronous operation system for discharge lamp lighting apparatuses according to Embodiment 1 of the present invention. In FIG. 2, one or more (three in this embodiment) discharge lamp lighting apparatuses have control circuit parts 1-1 to 1-3 of controller ICs (corresponding to the semiconductor integrated circuits of the present invention), SW networks 7-1 to 7-3, resonant circuits 9-1 to 9-3, and discharge lamps 3-1 to 3-3 arranged side by side on a panel 30, to light the discharge lamps 3-1 to 3-3. In each of the control circuit parts 1-1 to 1-3, a terminal RF is connected to a constant current determination resistor R2, a terminal CF is connected to a capacitor C2, and a terminal CS is connected to a capacitor C6.

Terminals TRI of the control circuit parts 1-1 to 1-3 are commonly connected to a common line 2a, terminals PS of the control circuit parts 1-1 to 1-3 are commonly connected to a common line 2b, and terminals PD of the control circuit parts 1-1 to 1-3 are commonly connected to a common line 2c.

In each of the discharge lamp lighting apparatuses, connected between a DC power source Vin and the ground is a first series circuit including a high-side p-type MOSFET Qp1 (referred to as p-type FET Qp1) and a low-side n-type MOSFET Qn1 (referred to as n-type FET Qn1). Connected between a connection point of the p-type FET Qp1 and n-type FET Qn1 and the ground GND is a series circuit including a capacitor C3 and a primary winding P of a transformer T. A first end of a secondary winding S of the transformer T is connected to a series circuit including a reactor Lr and a capacitor C4.

The p-type FET Qp1 has a source connected to the DC power source Vin and a gate connected to a terminal DRV1 of the control circuit part (1-1, 1-2, 1-3). A gate of the n-type FET Qn1 is connected to a terminal DRV2 of the control circuit part (1-1, 1-2, 1-3).

The first end of the secondary winding S of the transformer T is connected through the reactor Lr to a first electrode of the discharge lamp (3-1, 3-2, 3-3). A second electrode of the discharge lamp (3-1, 3-2, 3-3) is connected to a lamp current detection circuit including diodes D1 and D2 and resistors R3 and R4. The lamp current detection circuit detects a current passing through the discharge lamp (3-1, 3-2, 3-3) and outputs a voltage proportional to the detected current to a terminal FB (feedback) of the control circuit part (1-1, 1-2, 1-3) and to an inverting terminal (depicted by “-”) of an error amplifier 16.

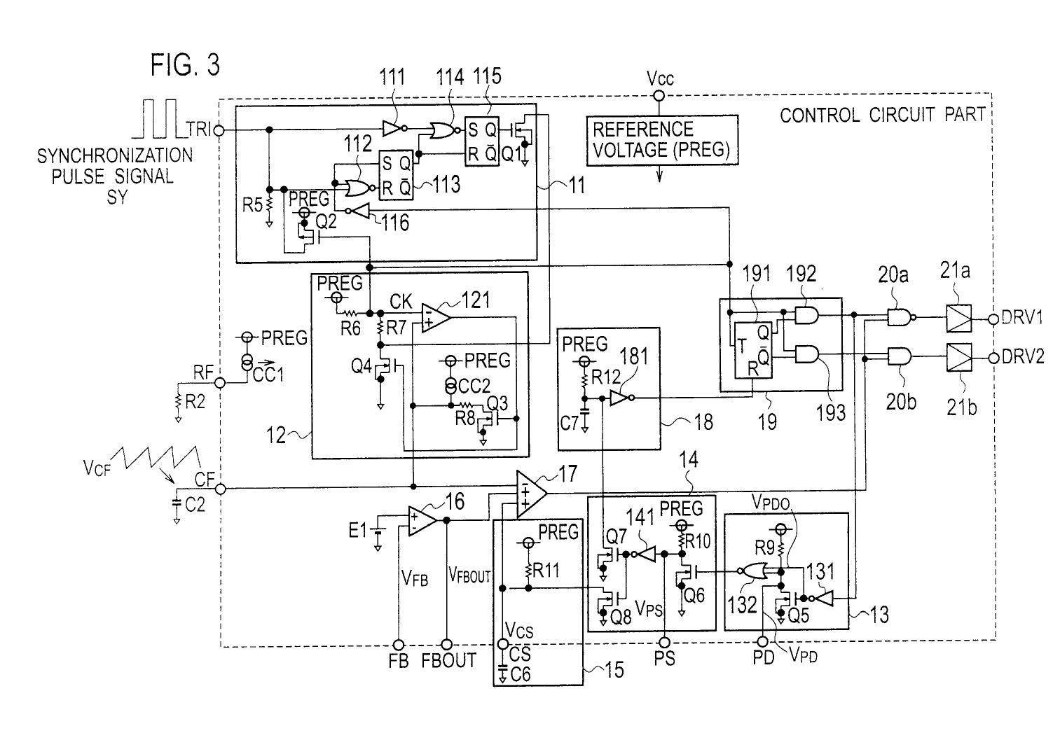

The control circuit part (1-1, 1-2, 1-3) includes, as illustrated in FIG. 3, a constant current source CC1, a constant current source CC2, a pulse synchronization circuit 11, a sawtooth-wave oscillator 12, a signal comparator 13, a restart circuit 14, a soft start circuit 15, the error amplifier 16, a PWM comparator 17, an initialization circuit 18, a frequency divider 19, a NAND gate 20a, an AND gate 20b, and drivers 21a and 21b.

Based on a voltage Vcc from the DC power source Vin, a reference voltage PREG is generated and is supplied to each internal part of the control circuit part (1-1, 1-2, 1-3). The constant current source CC1 is connected through the terminal RF to a first end of the constant current determination resistor R2 and supplies a constant current that is optionally set by the constant current determination resistor R2.

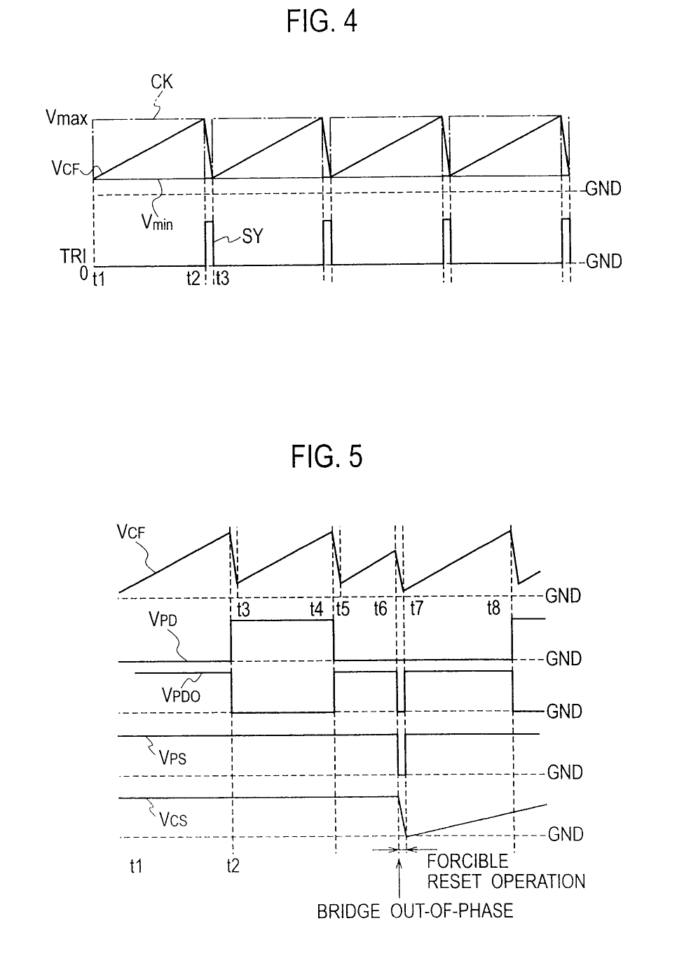

The sawtooth-wave oscillator 12 is connected through the terminal CF to a first end of the capacitor. C2, charges/discharges the capacitor C2 with a constant current from the constant current source CC2, generates a sawtooth signal VCF illustrated in FIG. 4, and generates a rectangular clock CK based on upper and lower limits of the sawtooth signal VCF. As illustrated in FIG. 4, the clock CK has a pulse voltage waveform that is synchronized with the sawtooth signal VCF and has a high-level rise period and a low-level fall period. The clock CK is sent to the frequency divider 19 and pulse synchronization circuit 11. The sawtooth-wave oscillator 12 generates the sawtooth signal VCF whose frequency is determined by the constant current determination resistor R2 and capacitor C2.

The sawtooth-wave oscillator 12 has the constant current source CC2, resistors R6, R7, and RB, FETs Q3 and Q4, and a comparator 121.

In the sawtooth-wave oscillator 12, the capacitor C2 is charged with the constant current from the constant current source CC2 when the FET Q3 is OFF, to increase the voltage of the capacitor C2, i.e., the signal level of the sawtooth signal VCF.

An inverting terminal of the comparator 121 is connected to a gate of an FET Q2 of the pulse synchronization circuit 11, a first end of the resistor R6, and a first end of the resistor R7. A second end of the resistor R6 is connected to the power source PREG. A second end of the resistor R7 is connected to a drain of the PET Q4. A non-inverting terminal of the comparator 121 is connected to the first end of the capacitor C2, a first end of the constant current source CC2, and a first end of the resistor R8. An output terminal of the comparator 121 is connected to gates of the FETs Q3 and Q4.

If the signal level of the sawtooth signal VCF exceeds a maximum signal level Vmax of the clock CK, the comparator 121 provides a high-level output to turn on the FETs Q3 and Q4. Then, the signal level of the clock CK decreases.

Further, the capacitor C2 discharges to decrease the signal level of the sawtooth signal VCF. If the signal level of the sawtooth signal VCF becomes equal to or lower than a minimum signal level Vmin of the clock CK, the comparator 121 provides a low-level output to turn off the FETs Q3 and Q4.

In this way, the terminal CF provides the sawtooth signal (VCF in FIG. 4) having the upper limit voltage Vmax and lower limit voltage Vmin and the clock CK is provided at a connection point of the resistors R6 and R7.

The error amplifier 16 amplifies an error voltage between a voltage VFB from the lamp current detection circuit to an inverting terminal and a reference voltage E1 to a non-inverting terminal and provides a non-inverting terminal of the PWM comparator 17 with an error voltage output VFBOUT. The soft start circuit 15 charges, when an FET Q8 is OFF, the capacitor C6 connected to the terminal CS and provides a non-inverting terminal of the PWM comparator 17 with a voltage VCS of the capacitor C6.

The PWM comparator 17 compares the error voltage output VFBOUT from the error amplifier 16 to the non-inverting terminal with the voltage VCS from the soft start circuit 15 to the non-inverting terminal, generates a pulse signal that is high if the lower signal is equal to or higher than the sawtooth signal VCF from the terminal CF to the inverting terminal and low if the lower signal is below the sawtooth signal VCF, and supplies the pulse signal to the NAND gate 20a and AND gate 20b.

The frequency divider 19 has a flip-flop circuit 191 and AND gates 192 and 193, to divide the frequency of the pulse signal (clock CK) from the sawtooth-wave oscillator and output the frequency-divided pulse signal through the AND gate 192 to the NAND gate 20a. The frequency-divided pulse signal is also inverted and outputted through the AND gate 193 to the AND gate 20b. The inverted frequency-divided pulse signal may have a predetermined dead time with respect to the frequency-divided pulse signal.

The NAND gate 20a operates a NAND logic of the frequency-divided pulse signal from the frequency divider 19 and the signal from the PWM comparator 17 and outputs a first drive signal through the driver 21a and terminal DRV1 to the p-type FET Qp1. The AND gate 20b operates an AND logic of the inverted frequency-divided pulse signal from the frequency divider 19 and the signal from the PWM comparator 17 and outputs a second drive signal through the driver 21h and terminal DRV2 to the n-type FET Qn1.

The PWM comparator 17, NAND gate 20a, and driver 21a generate the first drive signal within a half period of the sawtooth signal VCF, the first drive signal having a pulse width corresponding to a current passing through the discharge lamp (3-1, 3-2, 3-3) and driving the p-type FET Qp1 to pass a current through the discharge lamp (3-1, 3-2, 3-3).

The PWM comparator 17, AND gate 20b, and driver 21b generate the second drive signal having substantially the same pulse width as the first drive signal and a phase difference of about 180 degrees with respect to the first drive signal, to drive the n-type FET Qn1 so that a current is passed through the discharge lamp (3-1, 3-2, 3-3) in a direction opposite to that with the first drive signal.

Through the above-mentioned operation, the control circuit part (1-1, 1-2, 1-3) uses the first drive signal and the second drive signal that has substantially the same pulse width as the first drive signal and a phase difference of about 180 degrees with respect to the first drive signal, to alternately turn on/off the p-type FET Qp1 and n-type FET Qn1 at the frequency of the sawtooth signal VCF, thereby supplying power to the discharge lamp (3-1, 3-2, 3-3) and controlling a current passing through the discharge lamp (3-1, 3-2, 3-3) at a predetermined value.

Next, characteristic arrangements of the synchronous operation system for discharge lamp lighting apparatuses according to Embodiment 1 will be explained.

### (Pulse Synchronization Circuit)

The pulse synchronization circuit 11 has FETs Q1 and Q2, a resistor R5, inverters 111 and 116, NOR gates 112 and 114, and flip-flop circuits 113 and 115.

The FET Q2 turns on in response to a low level of the clock CK, i.e., the pulse signal provided by the sawtooth-wave oscillator 12 for transmitting frequency information and the pulse synchronization circuit 11 generates a synchronization pulse signal SY illustrated in FIG. 4. The synchronization pulse signal SY is outputted from the terminal TRI to the other control circuit parts through the common line 2a.

Further, the pulse synchronization circuit 11 receives at the terminal TRI a synchronization pulse signal SY from another control circuit part connected to the common line 2a. A high level of the synchronization pulse signal SY is inverted by the inverter 111 and a low level is supplied to an input terminal of the NOR gate 114.

On the other hand, the NOR gate 112 provides a high-level output when the clock CK (input to the inverter 116) is high and the synchronization pulse signal SY is low. If these conditions are met, the flip-flop circuit 113 is reset, and when the synchronization pulse signal SY changes to high, an output terminal Q of the flip-flop circuit 113 provides the NOR gate 114 with a low-level output. The NOR gate 114 provides a set terminal S of the flip-flop circuit 115 with a high-level output. The flip-flop circuit 115 provides from an output terminal Q a high-level output to turn on the FET Q1 and set the signal level of the clock CK to the voltage Vmin.

The signal level of the sawtooth signal VCF is higher than the voltage Vmin, and therefore, the comparator 121 provides a high-level output to turn on the FETs Q3 and Q4. As results, the capacitor C2 discharges.

Thereafter, the clock CK changes to low, the flip-flop circuit 113 is set, the flip-flop circuit 115 is reset, and the FET Q1 is turned off to start charging the capacitor C2.

Namely, the pulse synchronization circuit 11 detects a rise of the synchronization pulse signal SY from the outside (external signal), and at the timing of the rise, forcibly changes the capacitor C2, which generates the sawtooth signal VCF from its own sawtooth-wave oscillator 12, from charging to discharging, thereby synchronizing the sawtooth signal VCF with the external synchronization pulse signal.

When the pulse synchronization circuit 11 of its own is outputting the synchronization pulse signal SY to the outside (i.e., when the FET Q2 is ON), or when the sawtooth signal VCF of the sawtooth-wave oscillator 12 of its own is in a discharge period, the output terminal Q of the flip-flop circuit 113 provides the NOR gate 114 with a high-level output to turn off the FET Q1. Then, no change occurs on the sawtooth signal VCF of the sawtooth-wave oscillator 12.

### (Signal Comparator)

The signal comparator 13 has an inverter 131, a resistor R9, an FET Q5, and a NOR gate 132. The inverter 131 inverts the pulse signal, which has high and low levels representing phase information of the control signal, from the AND gate 192 and outputs an inverted pulse signal VPDO to the FET Q5 and NOR gate 132.

The NOR gate 132 compares the output VPDO from the inverter 131 with a pulse signal VPD received through a terminal PD from another control circuit part, and if the signal levels of both the signals are low, detects an out-of-phase of the switching elements Qp1 and Qn1 between the discharge lamp lighting apparatuses and provides the restart circuit 14 with an out-of-phase detected signal.

### (Restart Circuit)

The restart circuit 14 has a resistor R10, FETs Q6, Q7, and Q8, and an inverter 141. The FET Q6 turns on in response to the out-of-phase detected signal (high level) from the NOR gate 132 of the signal comparator 13, generates a low-level restart signal VPS, outputs the low-level restart signal VPS through the terminal PS to the common line 2b to operate restart circuits 14 of the other control circuit parts, and sends the signal VPS to the inverter 141 of its own.

The inverter 141 inverts the low-level signal from the signal comparator 13 into a high-level signal. The FETs Q7 and Q8 turn on in response to the high-level restart signal from the inverter 141, to operate the initialization circuit 18 and soft start circuit 15.

The initialization circuit 18 has a resistor R12, a capacitor C7, and an inverter 181. The soft start circuit 15 has a resistor R11 and the capacitor C6.

In the initialization circuit 18, the capacitor C7 discharges when the FET Q7 turns on and the voltage of the capacitor C7 decreases to provide the inverter 181 with a low-level output. The inverter 181 provides a reset terminal R of the flip-flop circuit 191 with a high-level output to forcibly reset the frequency divider 19.

In the soft start circuit 15, the capacitor C6 connected to the terminal CS discharges when the FET Q8 turns on, and thereafter, the capacitor. C6 is gradually charged with the resistor R11.

An out-of-phase detection operation will be explained with reference to a timing chart of FIG. 5. The terminal PD of the signal comparator 13 receives an external pulse signal. The inverter 131 outputs the inverted pulse signal VPDO. In a period from t1 to t6, the NOR gate 132 provides a low-level output to turn off the FET Q6. As a result, a high-level output is supplied to the terminal PS and the FETs Q7 and Q8 are turned off to increase the voltage VCS of the capacitor C6 at the terminal CS to high.

On the other hand, in a period from t6 to t7, the internal signal of the control circuit part becomes abnormal to decrease the pulse signal VPDO to low. Namely, a phase deviation occurs between the own control circuit part and another control circuit part. Then, the external pulse signal and the pulse signal from the inverter 131 both change to low and the NOR gate 132 provides a high-level output to turn on the FET Q6. This results in decreasing the signal VPS at the terminal PS to low, and at the same time, the signal VPS of another control circuit part connected to the common line 2b becomes low. Consequently, all control circuit parts restart.

The FETs Q7 and Q8 turn on due to the high-level signal from the inverter 141, to discharge the capacitor C6. The voltage VCS at the terminal CS decreases, and after time t7, the capacitor C6 is gradually charged.

The voltage VCS of the capacitor C6 is supplied to the non-inverting terminal of the PWM comparator 17. The PWM comparator 17 compares the error voltage output VFBOUT from the error amplifier 16 to the non-inverting terminal with the voltage VCS from the soft start circuit 15 and generates a pulse signal that is high if the lower signal is equal to or larger than the sawtooth signal VCF from the terminal CF to the inverting terminal and low if the lower signal is below the sawtooth signal VCF. The pulse signal is supplied to the NAND gate 20a and AND gate 20b. As a result, a soft start operation starts to gradually increase the ON periods of the drive signals for driving the switching elements Qp1 and Qn1.

As mentioned above, the synchronous operation system according to the embodiment forcibly charges/discharges the capacitor C2 in response to an external synchronization pulse signal, so that the control circuit parts 1-1 to 1-3 synchronously operate according to the external synchronization pulse signal.

Namely, the common line 2a is used to transmit a synchronization pulse signal among the discharge lamp lighting apparatuses, so that in-phase voltages of the same frequency are applied to the first ends of the discharge lamps 3-1 to 3-3. Even if the discharge lamp lighting apparatuses are arranged away from one another, positive-negative symmetrical AC power that is in phase and has the same frequency is stably and easily supplied to the loads.

If the switching elements Qp1 and Qn1 among the discharge lamp lighting apparatuses become out of phase, each control circuit part (1-1, 1-2, 1-3) detects the out-of-phase state through the terminal PD and the signal comparator 13 operates accordingly. At the same time, the restart circuit 14 operates through the terminal PS, to restart the discharge lamp lighting apparatus and achieve the soft start operation.

### Embodiment 2

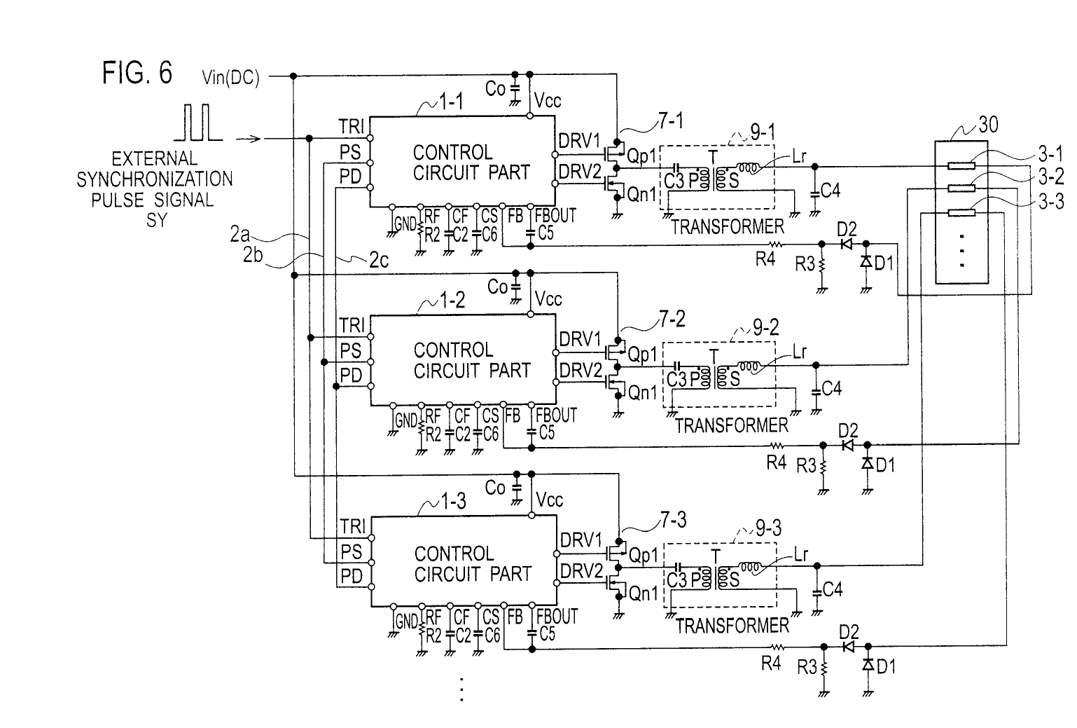

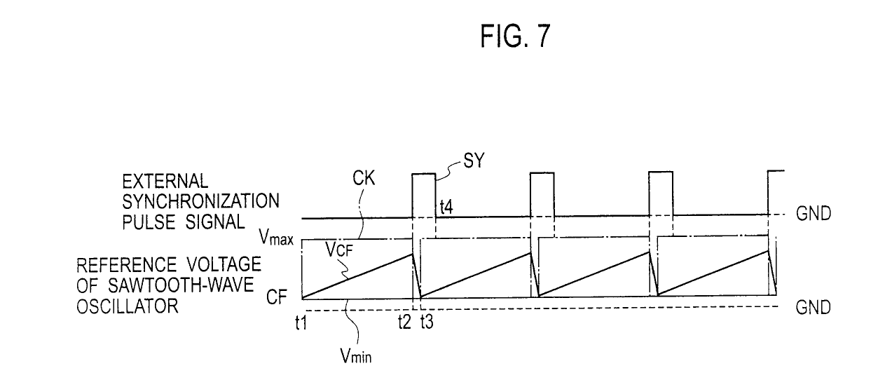

FIG. 6 is a schematic view of a synchronous operation system for discharge lamp lighting apparatuses according to Embodiment 2 of the present invention. The synchronous operation system for discharge lamp lighting apparatuses according to Embodiment 2 illustrated in FIG. 6 differs from the synchronous operation system for discharge lamp lighting apparatuses according to Embodiment 1 illustrated in FIG. 2 in that it inputs an external synchronization pulse signal to a terminal TRI of each control circuit part (1-1, 1-2, 1-3). FIG. 7 is a timing chart of a frequency synchronization operation in each discharge lamp lighting apparatus according to Embodiment 2 illustrated in FIG. 6.

The synchronous operation system for discharge lamp lighting apparatuses according to Embodiment 2 operates in a similar manner to the synchronous operation system for discharge lamp lighting apparatuses according to Embodiment 1 and provides similar effect.

### Embodiment 3

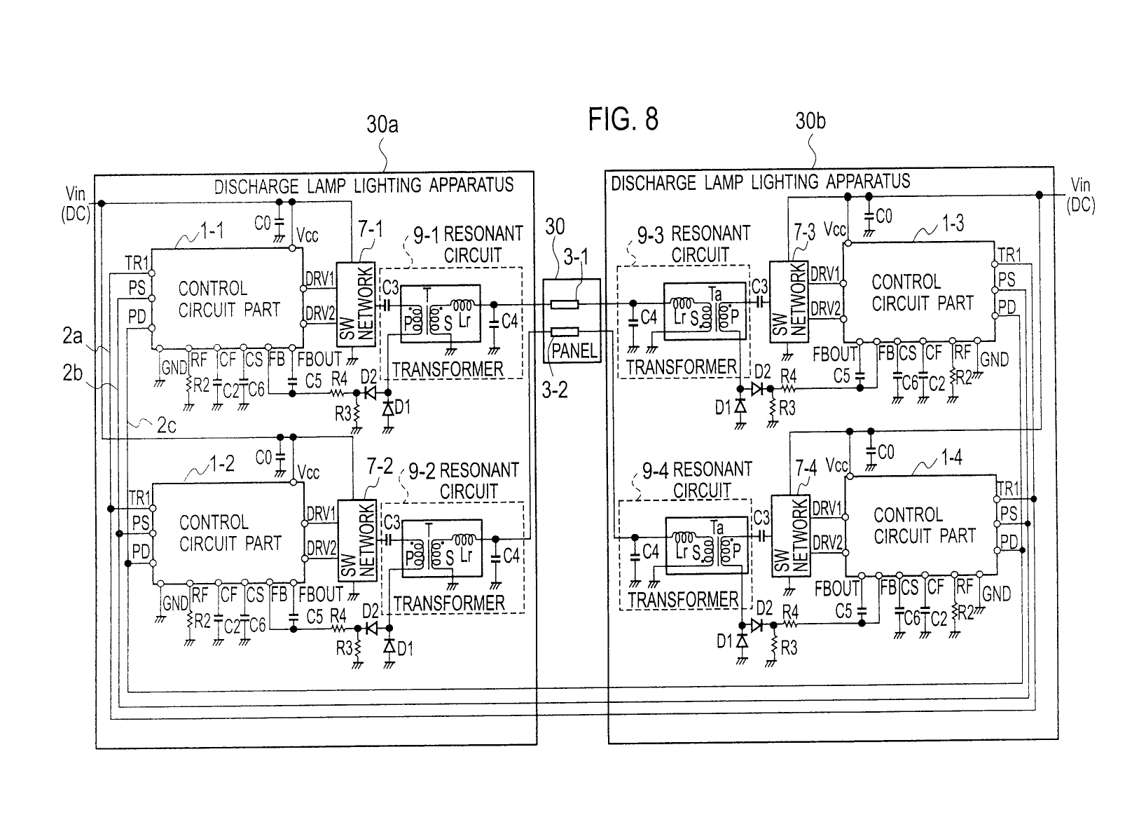

FIG. 8 is a schematic view of a synchronous operation system for discharge lamp lighting apparatuses according to Embodiment 3 of the present invention. In FIG. 8, discharge lamp lighting apparatuses 30a and 30b are arranged on opposite sides of a panel 3 on which discharge lamps 3-1 and 3-2 are arranged.

The discharge lamp lighting apparatus 30a has control circuit parts 1-1 and 1-2, SW networks 7-1 and 7-2, resonant circuits 9-1 and 9-2, and lamp current detection circuits each with diodes D1 and D2 and resistors R3 and R4. An output of the resonant circuit 9-1 is connected to a first end of the discharge lamp 3-1 and an output of the resonant circuit 9-2 is connected to a first end of the discharge lamp 3-2.

The discharge lamp lighting apparatus 30b has control circuit parts 1-3 and 1-4, SW networks 7-3 and 7-4, resonant circuits 9-3 and 9-4, and lamp current detection circuits each with diodes D1 and D2 and resistors R3 and R4.

An output of the resonant circuit 9-3 is connected to a second end of the discharge lamp 3-1 and an output of the resonant circuit 9-4 is connected to a second end of the discharge lamp 3-2.

Terminals TRI of the control circuit parts 1-1 to 1-4 are commonly connected to a common line 2a, terminals PS of the control circuit parts 1-1 to 1-4 are commonly connected to a common line 2b, and terminals PD of the control circuit parts 1-1 to 1-4 are commonly connected to a common line 2c.

Secondary windings S of transformers T connected to the first ends of the discharge lamps 3-1 and 3-2 are differently polarized from secondary windings S of transformers Ta connected to the second ends of the discharge lamps 3-1 and 3-2. Accordingly, the opposite ends of the discharge lamps 3-1 and 3-2 receive voltages of opposite phases.

The synchronous operation system for discharge lamp lighting apparatuses according to the present embodiment transmits a synchronization pulse signal among the control circuit parts 1-1 to 1-4 of the discharge lamp lighting apparatuses through the common line 2a, to apply voltages of the same frequency and opposite phases to the opposite ends of each of the discharge lamps 3-1 and 3-2 and light the discharge lamps 3-1 and 3-2.

The terminals TRI of the control circuit parts 1-1 to 1-4 of Embodiment 3 may receive an external synchronization pulse signal. This case also provides the effect of Embodiment 3.

### Embodiment 4

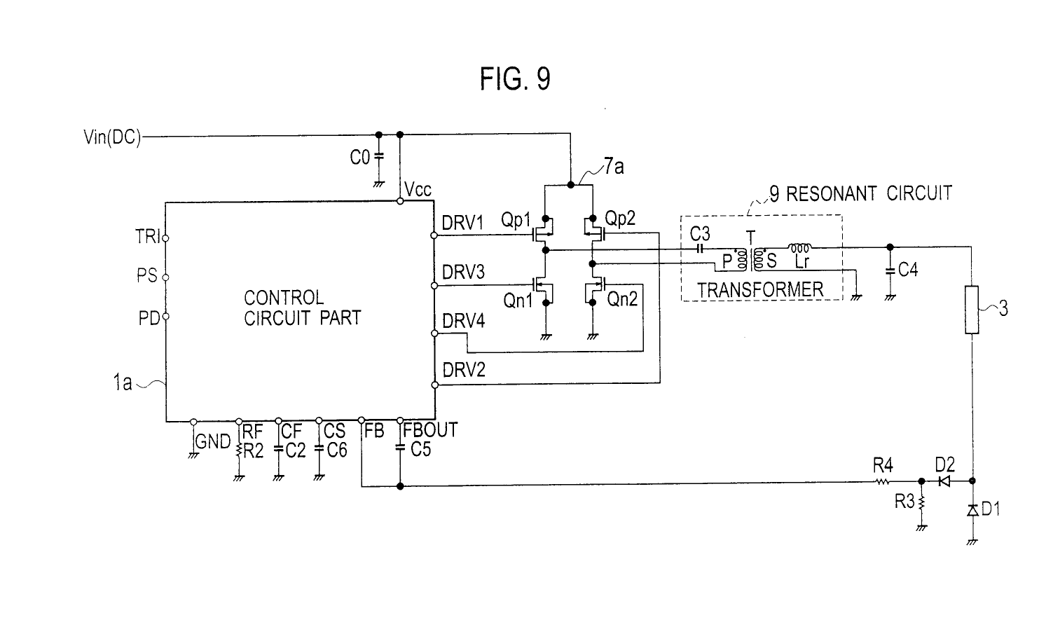

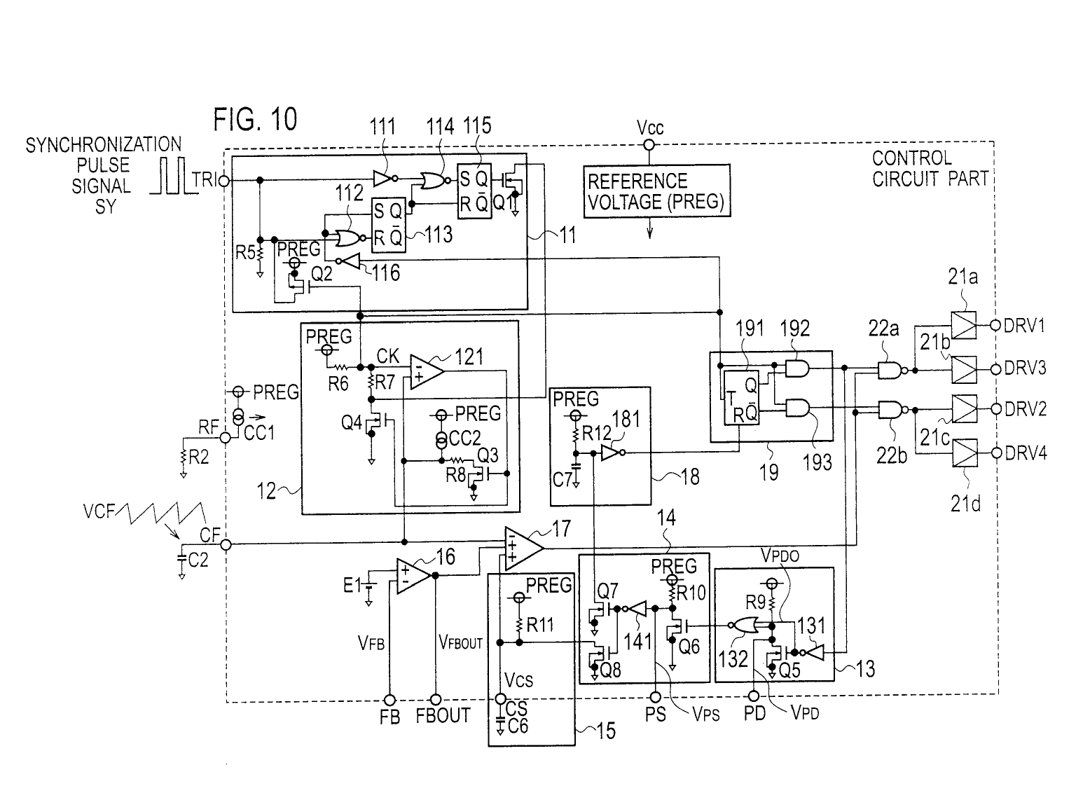

FIG. 9 is a schematic view of a discharge lamp lighting apparatus according to Embodiment 4 of the present invention. FIG. 10 is a schematic view of a control circuit part arranged in the discharge lamp lighting apparatus of Embodiment 4 illustrated in FIG. 9. A plurality of discharge lamp lighting apparatuses each being the one illustrated in FIG. 9 may be connected in parallel with one another to form a synchronous operation system for discharge lamp lighting apparatuses.

The discharge lamp lighting apparatuses of Embodiments 1 to 3 each employ the SW network 7 of half-bridge configuration having the switching elements Qp1 and Qn1. The discharge lamp lighting apparatus of Embodiment 4 is characterized by employing an SW network 7a of full-bridge configuration having switching elements Qp1, Qn1, Qp2, and Qn2.

In FIG. 9, connected between a DC power source Vin and the ground is a first series circuit including the p-type FET Qp1 and n-type FET Qn1. Connected between the DC power source Vin and the ground is a second series circuit including the p-type FET Qp2 and n-type FET Qn2.

Connected between a connection point of the p-type FET Qp1 and n-type FET Qn1 and a connection point of the p-type FET Qp1 and n-type FET Qn1 is a series circuit including a capacitor C3 and a primary winding P of a transformer T.

A source of the p-type FET Qp1 is connected to the DC power source Vin and a gate of the p-type FET Qp1 is connected to a terminal DRV1 of the control circuit part 1a. A gate of the n-type FET Qn1 is connected to a terminal DRV3 of the control circuit part 1a.

A source of the p-type FET Qp2 is connected to the DC power source Vin and a gate of the p-type FET Qp2 is connected to a terminal DRV2 of the control circuit part 1a. A gate of the n-type FET Qn1 is connected to a terminal DRV4 of the control circuit part 1a.

A first end of a secondary winding S of the transformer T is connected through a reactor Lr to a first electrode of a discharge lamp 3. A second electrode of the discharge lamp 3 is connected to a lamp current detection circuit including diodes D1 and D2 and resistors R3 and R4.

The control circuit part 1a illustrated in FIG. 10 differs from the control circuit part illustrated in FIG. 3 in the configuration of drivers. Namely, the control circuit part 1a has NAND gates 22a and 22b and drivers 21a to 21d. The NAND gate 22a operates a NAND logic of an output from an AND gate 192 and an output from a PWM comparator 17 and provides the drivers 21a and 21b with a NAND output. The NAND gate 22b operates a NAND logic of an output from an AND gate 193 and the output from the PWM comparator 17 and provides the drivers 21c and 21d with a NAND output.

The discharge lamp lighting apparatus of Embodiment 4 operates like the discharge lamp lighting apparatuses of Embodiment 1 to Embodiment 3 and provides similar effect.

The present invention is not limited to the synchronous operation systems for discharge lamp lighting apparatuses of Embodiments 1 to 4. The discharge lamp lighting apparatuses of Embodiments 1 to 4 each detect a high level (rise) of a synchronization pulse signal (trigger signal) with the pulse synchronization circuit 11, to establish synchronization. Instead, the pulse synchronization circuit 11 may detect a low level (fall) of the trigger signal, to establish synchronization.

Although the discharge lamp lighting apparatuses of Embodiments 1 to 4 each employ the sawtooth-wave oscillator 12, it is possible to employ a triangular-wave oscillator for generating a triangular signal.

Outputs from the terminals DRV1, DRV3, DRV2, and DRV4 illustrated in FIG. 9 may have a dead time to prevent a simultaneous ON state.

The discharge lamps may be CCFLs, EEFLs, or series connections each including a capacitor and a discharge lamp.

### EFFECT OF INVENTION

The present invention transmits a synchronization pulse signal among discharge lamp lighting apparatuses through a common line, to apply in-phase voltages of the same frequency to both ends of at least one discharge lamp. Even if the discharge lamp lighting apparatuses are separated away from one another, the load stably and easily receives positive-negative-symmetric AC power in the same or opposite phases at the same frequency.

Alternatively, a synchronization pulse signal supplied from the outside of the system is used as a reference, so that the load stably and easily receives positive-negative-symmetric AC power in the same or opposite phases at the same frequency even if the discharge lamp lighting apparatuses are arranged away from one another.

### UNITED STATES DESIGNATION

In connection with United States designation, this application claims benefit of priority under 35 USC §119 to Japanese Patent Application No. 2008-076155 filed on Mar. 24, 2008, the entire contents of which are incorporated by reference herein.

1. A synchronous operation system for discharge lamp lighting apparatuses, comprising one or more discharge lamp lighting apparatuses that are connected to one another with a common line and are configured to supply AC power to one or more discharge lamps, each of the one or more discharge lamp lighting apparatuses including:
a resonant circuit having a capacitor connected to at least one of primary and secondary windings of a transformer and an output connected to the discharge lamp;
a plurality of switching elements being connected to both ends of a DC power source and configured to pass a current through the primary winding of the transformer and the capacitor of the resonant circuit;
a sawtooth-wave oscillator generating a sawtooth signal for PWM-controlling the plurality of switching elements;
a PWM comparator configured to output a PWM signal for controlling the plurality of switching elements based on the sawtooth signal from the sawtooth-wave oscillator; and
a pulse synchronization circuit configured to provide the common line with a synchronization pulse signal based on a pulse signal that carries frequency information about the sawtooth signal from the sawtooth-wave oscillator, and when receiving a synchronization pulse signal from the common line, synchronize the oscillation frequency of the sawtooth signal from the sawtooth-wave oscillator with the frequency of the synchronization pulse signal from the common line, wherein
the synchronization pulse signal is transmitted/received among the one or more discharge lamp lighting apparatuses through the common line, so that a voltage of aligned frequency and phase is applied to one end of each of the one or more discharge lamps for lighting the one or more discharge lamps.

2. A synchronous operation system for discharge lamp lighting apparatuses, comprising one or more discharge lamp lighting apparatuses that are connected to one another with a common line and are configured to supply AC power to one or more discharge lamps, each of the one or more discharge lamp lighting apparatuses including:
a resonant circuit having a capacitor connected to at least one of primary and secondary windings of a transformer and an output connected to the discharge lamp;
a plurality of switching elements being connected to both ends of a DC power source and passing a current through the primary winding of the transformer and the capacitor in the resonant circuit;
a sawtooth-wave oscillator generating a sawtooth signal for PWM-controlling the plurality of switching elements;
a PWM comparator configured to output a PWM signal for controlling the plurality of switching elements based on the sawtooth signal from the sawtooth-wave oscillator; and
a pulse synchronization circuit configured to provide the common line with a synchronization pulse signal based on a pulse signal that carries frequency information about the sawtooth signal from the sawtooth-wave oscillator, and when receiving a synchronization pulse signal from the common line, synchronize the oscillation frequency of the sawtooth signal from the sawtooth-wave oscillator with the frequency of the synchronization pulse signal from the common line, wherein
the synchronization pulse signal is transmitted/received among the one or more discharge lamp lighting apparatuses through the common line, so that voltages of aligned frequency and opposite phases are applied to both ends of each of the one or more discharge lamps for lighting the one or more discharge lamps.

3. The synchronous operation system for discharge lamp lighting apparatuses according to claim 1, wherein each of the one or more discharge lamp lighting apparatuses includes:
a signal comparator configured to provide the common line with a pulse signal that carries phase information about the PWM signal for the plurality of switching elements, and if receiving from the common line a pulse signal whose phase differs from the phase of the pulse signal of its own, output an out-of-phase detected signal; and
a restart circuit configured to reset the pulse signal according to the out-of-phase detected signal from the signal comparator, generate a restart signal for restarting each discharge lamp lighting apparatus, and output the restart signal to the common line.

4. The synchronous operation system for discharge lamp lighting apparatuses according to claim 2, wherein each of the one or more discharge lamp lighting apparatuses includes:
a signal comparator configured to provide the common line with a pulse signal that carries phase information about the PWM signal for the plurality of switching elements, and if receiving from the common line a pulse signal whose phase differs from the phase of the pulse signal of its own, output an out-of-phase detected signal; and
a restart circuit configured to reset the pulse signal according to the out-of-phase detected signal from the signal comparator, generate a restart signal for restarting each discharge lamp lighting apparatus, and output the restart signal to the common line.

5. The synchronous operation system for discharge lamp lighting apparatuses according to claim 3, wherein each of the discharge lamp lighting apparatuses includes
a soft start circuit configured to conduct a soft start operation that gradually increases an ON period of drive signals for driving the plurality of switching elements according to the restart signal from the restart circuit.

6. The synchronous operation system for discharge lamp lighting apparatuses according to claim 4, wherein each of the discharge lamp lighting apparatuses includes
a soft start circuit configured to conduct a soft start operation that gradually increases an ON period of drive signals for driving the plurality of switching elements according to the restart signal from the restart circuit.

7. A discharge lamp lighting apparatus comprising:
a resonant circuit having a capacitor connected to at least one of primary and secondary windings of a transformer, a discharge lamp being connected to an output;
a plurality of switching elements connected to both ends of a DC power source, configured to pass a current through the primary winding of the transformer and the capacitor of the resonant circuit;
a sawtooth-wave oscillator configured to generate a sawtooth signal for PWM-controlling the plurality of switching elements;
a PWM comparator to output a PWM signal for controlling the plurality of switching elements based on the sawtooth signal from the sawtooth-wave oscillator; and
a pulse synchronization circuit configured to provide the outside with a synchronization pulse signal based on a pulse signal that carries frequency information about the sawtooth signal from the sawtooth-wave oscillator, and when receiving a synchronization pulse signal from the outside, synchronize the oscillation frequency of the sawtooth signal from the sawtooth-wave oscillator with the frequency of the synchronization pulse signal from the outside.

8. The discharge lamp lighting apparatus according to claim 7, comprising:
a signal comparator configured to provide the outside with a pulse signal that carries phase information about the PWM signal for the plurality of switching elements, and if receiving from the outside a pulse signal whose phase differs from the phase of the pulse signal of its own, output an out-of-phase detected signal; and
a restart circuit configured to reset the pulse signal according to the out-of-phase detected signal from the signal comparator, generate a restart signal for restarting each discharge lamp lighting apparatus, and output the restart signal to the outside.

9. The discharge lamp lighting apparatus according to claim 8, comprising
a soft start circuit configured to conduct a soft start operation that gradually increases an ON period of drive signals for driving the plurality of switching elements according to the restart signal from the restart circuit.

10. A semiconductor integrated circuit for controlling a plurality of switching elements that turn on/off a power source to supply power to a load, comprising:
a sawtooth-wave oscillator generating a sawtooth signal for PWM-controlling the plurality of switching elements;
a PWM comparator configured to output a PWM signal for controlling the plurality of switching elements based on the sawtooth signal from the sawtooth-wave oscillator; and
a pulse synchronization circuit configured to provide the outside with a synchronization pulse signal based on a pulse signal that carries frequency information about the sawtooth signal from the sawtooth-wave oscillator,
and when receiving a synchronization pulse signal from the outside, synchronize the oscillation frequency of the sawtooth signal from the sawtooth-wave oscillator with the frequency of the synchronization pulse signal from the outside.

11. The semiconductor integrated circuit according to claim 10, comprising:
a signal comparator configured to provide the outside with a pulse signal that carries phase information about the PWM signal for the plurality of switching elements, and if receiving from the outside a pulse signal whose phase differs from the phase of the pulse signal of its own, output an out-of-phase detected signal; and
a restart circuit configured to reset the pulse signal according to the out-of-phase detected signal from the signal comparator, generate a restart signal for restarting each discharge lamp lighting apparatus, and output the restart signal to the outside.

12. The semiconductor integrated circuit according to claim 11, comprising
a soft start circuit configured to conduct a soft start operation that gradually increases an ON period of drive signals for driving the plurality of switching elements according to the restart signal from the restart circuit.
